(19) United States
(12) Patent Application Publication
(10) Pub. No.: US 2006/0247833 A1
(43) Pub. Date: Nov. 2, 2006

(54) System and method for remote acquisition of automotive data from a vehicle

(76) Inventors: Anupam Malhotra, Troy, MI (US); Richard W. Meoak, Brighton, MI (US); Mark E. Gilbert, Ann Arbor, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/117,789

(22) Filed: Apr. 29, 2005

(51) Int. Cl. G06F 19/00

(52) U.S. Cl. 701/33; 701/35; 340/438

(57) ABSTRACT

Systems and methods are provided for wirelessly transferring automotive usage data from a vehicle electrical infrastructure to a remote site. The system includes a data recorder in operable communication with the vehicle electrical infrastructure, a mass storage unit in operable communication with the data recorder, and a communication module coupled to the mass storage device. The data recorder is configured to retrieve the automotive usage data from the vehicle electrical infrastructure. The mass storage unit is configured to store the automotive usage data. The communication module is configured to wirelessly transmit the automotive usage data to the remote site.

### TECHNICAL FIELD

The present invention generally relates to acquisition of automotive data, and more particularly relates to remote acquisition of automotive data.

### BACKGROUND OF THE INVENTION

Automotive data acquisition for a variety of automotive products serves to advance automotive technology and provide valuable customer service. The term automotive data acquisition is used herein to refer to a process of recording data in an automotive environment, such as in a car, truck, bus, or any other category of automobile. Examples of automotive data include, but are not limited to, basic usage information, structural characteristics, vehicle operation, occupant inputs, diagnostics, environment (e.g., temperature, humidity, vibration), performance, location, and terrain.

Acquiring customer usage data for automotive products may be accomplished through a variety of methods. To record basic customer usage information, environmental data, terrain information, occupant inputs, or other similar parameters associated with a particular vehicle, the manufacturer typically installs a customer data acquisition system in the vehicle. This data acquisition system generally includes one or more data recorders, interconnect wiring, sensors, and/or transducers.

Currently, two techniques are used to retrieve the automotive data. The first technique involves delivering the vehicle to a service facility and the second technique involves travel by a service representative to the location of the vehicle. However, other techniques are continuously sought to retrieve the automotive data from vehicles.

Accordingly, it is desirable to provide a system for acquiring automotive customer usage data from a vehicle. In addition, it is desirable to provide a method for acquiring automotive customer usage data from a vehicle. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

A system is provided for transferring automotive usage data from a vehicle electrical infrastructure to a remote site. The system comprises a data recorder in operable communication with the vehicle electrical infrastructure, a mass storage unit in operable communication with the data recorder, and a communication module coupled to the mass storage device. The data recorder is configured to retrieve the automotive usage data from the vehicle electrical infrastructure. The mass storage unit is configured to store the automotive usage data. The communication module is configured to wirelessly transmit the automotive usage data to the remote site.

A method is provided of gathering automotive usage data of a vehicle at a remote site, the method comprising the steps of receiving the automotive usage data from a vehicle electrical infrastructure of the vehicle, storing the automotive usage data received from the vehicle electrical infrastructure in a memory of the vehicle, and wirelessly transmitting the automotive usage data stored in the memory to the remote site.

A system is provided for acquiring automotive usage data from a vehicle, the system comprises a vehicle subsystem, a telematics subsystem configured to manage communications to and from the vehicle subsystem, and a remote data processor. The vehicle subsystem comprises a data recorder having an output and having a first input configured to couple with a vehicle electrical infrastructure of the vehicle, and a mass storage unit having a first input coupled to the output of the data recorder and configured to store the automotive usage data. The data recorder is configured to retrieve the automotive usage data from the vehicle electrical infrastructure. The telematics subsystem comprises a collection node and a communication module coupled to the mass storage device. The communication module is configured to transmit the automotive usage data to the collection node. The remote data processor is configured to wirelessly receive the automotive usage data from the collection node via the communication module.

### DESCRIPTION OF THE DRAWINGS

The present invention will hereinafter be described in conjunction with the following drawing figures, wherein like numerals denote like elements, and

FIG. 1 is a schematic diagram illustrating a system for acquiring automotive usage data from a vehicle in accordance with an exemplary embodiment;

FIG. 2 is a schematic diagram of a vehicle subsystem in accordance with an exemplary embodiment; and

FIG. 3 is a flowchart of a remote acquisition of automotive data in accordance with an exemplary embodiment.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Generally, a system is provided for acquiring automotive usage data from the vehicle electrical infrastructure of a vehicle. The system comprises a data recorder configured to couple with the vehicle electrical infrastructure, a mass storage unit coupled to the data recorder, and a communication module coupled to the mass storage device. In operation, the data recorder retrieves the automotive usage data from the vehicle electrical infrastructure, the mass storage unit stores the automotive usage data, and the communication module wirelessly transmits the automotive usage data to a remote site for data processing and analysis. Although the system is described with regard to acquiring automotive data from a single vehicle electrical infrastructure, the system may acquire automotive data from multiple vehicles, with each of the vehicles having a vehicle electrical infrastructure and one or more optional vehicle-situated sensors or transducers, to satisfy a predetermined statistical population for data analysis. Additionally, the system may acquire automotive usage data at predetermined times or upon designated occurrences of events from the vehicle electrical infrastructure.

The vehicle electrical infrastructure includes, but is not necessarily limited to, various systems and/or subsystems on the vehicle, including by way of example and not of limitation a human vehicle interface, a battery power management system, an engine management system, a transmission management system, a body control module, and vehicle subsystems such as an Antilock Brake System (ABS). In general, the vehicle electrical infrastructure controls various components of the vehicle and may use a feedback scheme to accomplish such control by comparing transmitted signals (i.e., control signals) with received signals that indicate the response of a particular vehicle component (e.g., velocity, temperature, etc.).

In addition to the vehicle electrical infrastructure, data acquisition may optionally obtain automotive usage data from a variety of different vehicle sensors, either pre-existing on the vehicle or mounted on the vehicle subsequent to customer purchase. Examples of some pre-existing vehicle sensors include, but are not necessarily limited to, Pedal Position Sensors (PPSs), Throttle Position Sensors (TPSs), Mass Air Flow (MAF) sensors, and Manifold Absolute Pressure (MAP) sensors. Generally, the PPS monitors the position of the accelerator pedal, the TPS monitors the position of the throttle valve, the MAF sensor, which is positioned at the air intake manifold, measures airflow into the engine, and the MAP sensor senses intake manifold air pressure.

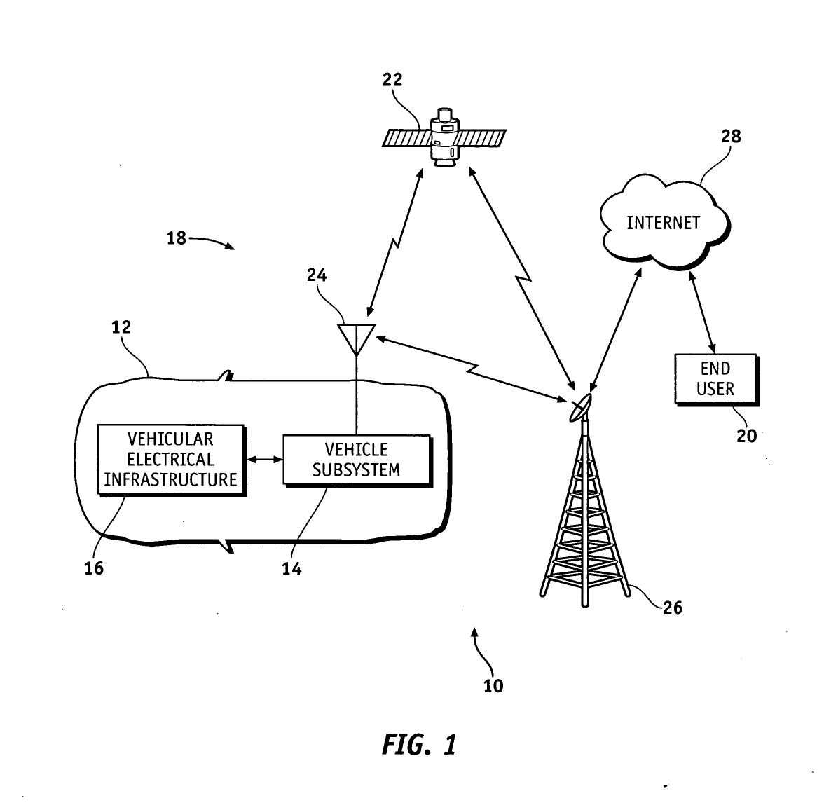

Referring to FIG. 1, a system 10 for acquiring automotive usage data from a vehicle 12 is illustrated in accordance with an exemplary embodiment. The data acquisition system 10 comprises a vehicle subsystem 14 configured to couple with a conventional vehicle electrical infrastructure 16, a wireless communications subsystem 18, and a back-office subsystem 20 (e.g., end user). The vehicle subsystem 14 obtains automotive usage data from the vehicle electrical infrastructure, from vehicle sensors, from transducers on the vehicle 12, or a combination thereof, as described in greater detail hereinafter.

In general, the vehicle subsystem 14 of the data acquisition system 10 includes components, such as a control interface, that connect the internal communication network(s) of the vehicle 12 (e.g., Controller Area Network (CAN), J1850 type communication networks, and the like) to the vehicle subsystem 14 for gathering automotive usage data. For example, the vehicle subsystem 14 includes components (e.g., hardware, software, protocols, etc.) that permit communication between the vehicle subsystem 14 and the vehicle electrical infrastructure 16 using one or more of the communication networks native to the vehicle electrical infrastructure 16, and the vehicle subsystem 14 gathers a variety of data from the vehicle electrical infrastructure 16 generated during operation of the vehicle 12 via these communication networks. The vehicle subsystem 14 may be integrated with the vehicle electrical infrastructure 16 or separately coupled to the vehicle electrical infrastructure 16 via a vehicle network data bus, as described in greater detail hereinafter.

The wireless communications subsystem 18 of the data acquisition system 10 transfers information between the vehicle 12 and the back-office subsystem 20 and includes a variety of resources (e.g., protocols, equipment, interfaces, back-haul, and standards) for establishing, utilizing, and managing wireless communication channels to and from the vehicle 12. These wireless communication channels may be used for a variety of communications such as communications between vehicles, between the vehicle 12 and a cellular phone connection point, between the vehicle 12 and a satellite 22, between the vehicle and a diagnostic system, etc.

The wireless communications subsystem 18 also includes, but is not necessarily limited to, a communications module coupled with the vehicle subsystem 14, a collection node configured to collect the automotive usage data from the communications module, and a network 28, such as the Internet, configured to couple the collection node with the back-office subsystem 20. The communications module transmits automotive usage data to and receives information from the back-office subsystem 20 (e.g., control commands, diagnostic applications, and the like) via an antenna 24, and preferably transmits automotive usage data and receives information from the back-office subsystem 20 using conventional cellular communication signal processing or conventional Wireless Local Area Network (WLAN) communication systems.

During the course of data transmission from the communications module, the automotive usage data is routed to the collection node, such as a satellite 22, a ground station 26, or a server, for access by the back-office subsystem 20. The collection node includes a memory for storing the automotive usage data. In a WLAN embodiment, the ground station 26 is coupled to the network 28 as a node in the network 28, and the communications module wirelessly transfers the automotive usage data to the ground station 26 via the satellite 22. The back-office subsystem 20 may couple with the network 28 to access the automotive usage data.

In one exemplary embodiment, the data acquisition system 10 uses a telematics service provided by a Telematics Service Provider (TSP), such as OnStar and ATX, to transmit automotive usage data, and the telematics system supports bi-modal voice and data communication. The term telematics is used herein to refer to a combined application of telecommunications and informatics (e.g., information management through information technology). Telematics-based products and service may retrieve, store, process, and communicate information including voice, sound, text, graphics, images, and video. For example, when a service request is initiated by the back-office subsystem 20, the TSP delivers the vehicle identification, location, speed, and direction information to the back-office subsystem 20, and the TSP appropriately channels services.

The back-office subsystem 20 of the data acquisition system 10 channels and analyzes the automotive usage data for event management and also provides an interface to third party content and service providers, such as weather, news, entertainment information providers, and emergency response agencies. Examples of the back-office subsystem 20 include, but are not necessarily limited to, an automated data-center and a staffed call-center. The back-office subsystem 20 may simultaneously and automatically sort, group, and accumulate data from multiple vehicles in multiple consumer applications. The back-office subsystem 20 preferably includes, but is not necessarily limited to, a server having one or more end-user interfaces and having a mass data storage device for storing the automotive usage data. The server is coupled with the network 28 to retrieve the automotive usage data from the collection node and transmit vehicle support information (e.g., updated diagnostic applications, data acquisition procedures, and the like) to a desired vehicle. The back-office subsystem 20 may scale both volume and services and includes software and hardware elements and applications for responding to service requests from end users (e.g., data analysts).

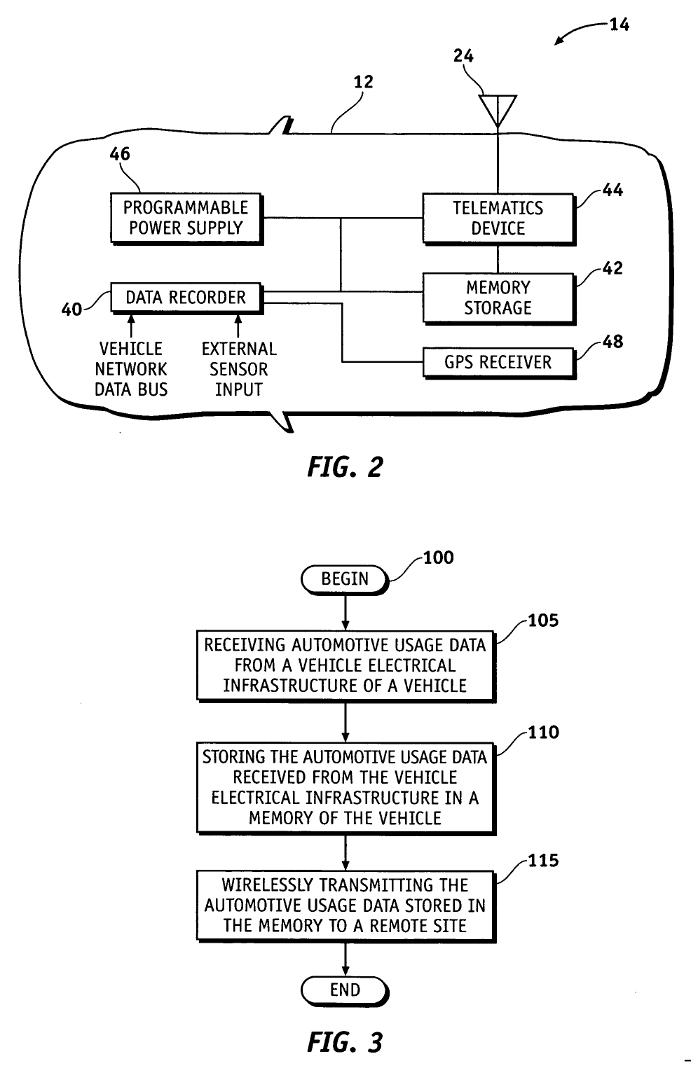

FIG. 2 is a schematic diagram of the vehicle subsystem 14 in accordance with an exemplary embodiment. The vehicle subsystem 14 comprises a data recorder 40, a mass data storage unit 42 having a first input coupled to an output of the data recorder 40, the communications module 44 coupled to a second input of the mass data storage unit 42, and a programmable power supply 46 coupled to the data recorder 40, the mass data storage unit 42, and the communications module 44. Additionally, the mass data storage unit 42 has a second input coupled to the communications module 44 for receiving and storing updated data acquisition applications or other instructions from the back-office subsystem 20 shown in FIG. 1, as described in greater detail hereinafter. The vehicle subsystem 14 may additionally include a Global Positioning System (GPS) receiver 48 coupled to the data recorder 40 for obtaining location specific or movement based automotive usage data, as well as one or more software elements, such as a voice recognition engine for hands-free operation of the vehicle 12 when driving.

The data recorder 40 of the vehicle system 14 includes, but is not necessarily limited to, a first input configured to couple with the vehicle electrical infrastructure 16 as shown in FIG. 1, such as via a vehicle network data bus, and a second input configured to couple with one or more external sensors. In an exemplary embodiment, the data recorder 40 retrieves automotive usage data from various components of the vehicle 12 that are coupled to the vehicle electrical infrastructure 16 as well as from vehicle sensors/transducers.

The mass data storage unit 42, which is storing the automotive usage data retrieved by the data recorder 40, includes one or more memory buffers for information storage and preferably stores collected automotive usage data from the data recorder 40 and any current or updated data acquisition applications uploaded from the back-office subsystem 20. Retrieval of various automotive usage data may be specified by these data acquisition applications and executed by the data recorder 40. For example, the data recorder 40 may retrieve automotive usage data at predetermined time periods. For example, upon the occurrence of a predetermined condition (e.g., end of an ignition cycle, observation of a designated diagnostic code, attaining a pre-determined amount of memory storage, and the like), the communications module 44 transmits the automotive usage data to the back-office subsystem 20 as shown in FIG. 1.

In an exemplary embodiment, the communications module 44 comprises a transceiver for establishing and maintaining a wireless communications link (e.g., via cellular communications, WLAN, Bluetooth, and the like) with the wireless communications subsystem 18 as shown in FIG. 1. The transceiver performs signal processing (e.g., digitizing, data encoding, modulation, etc.) on the automotive usage data and transmits the automotive usage data to the satellite 22 or ground station 26 as shown in FIG. 1. In another exemplary embodiment, the transceiver may also receive updated data acquisition applications and other instructions from the back-office subsystem 20 as shown in FIG. 1 and performs the corresponding signal processing (e.g., demodulation, decoding, etc.) to extract the originally transmitted information.

The programmable power supply 46, which supplies and regulates power to the communications module 44, the mass data storage unit 42, and the data recorder 40, may be coupled to a vehicle battery via the vehicle electrical infrastructure 16 as shown in FIG. 1, and thus the programmable power supply 46 supplies power to the vehicle subsystem 14 or portions of the vehicle subsystem 14. A number of different vehicle systems, each having varying power demands, may be connected to the vehicle battery, and the programmable power supply 46 preferably supplies power to the vehicle subsystem 14 or portions of the vehicle subsystem 14 as instructed by a power management scheme. The power management scheme preferably details events or thresholds for controlling the power supplied to the data recorder 40, the mass data storage unit 42, and the communications module 44 while additionally monitoring the current power level of the vehicle battery. For example, the programmable power supply 46 may activate the vehicle subsystem 14 until the power level of the vehicle battery falls below a predetermined threshold, and thus the communications module 44 may transmit the automotive usage data while the engine is turned-off until the power level of the vehicle battery reaches the predetermined threshold or upon the occurrence of an event defined by the power management scheme.

FIG. 3 is a flowchart of a remote acquisition of automotive data in accordance with an exemplary embodiment. The method begins at step 100. The data recorder 40 shown in FIG. 2 receives automotive usage data from the vehicle electrical infrastructure 16 shown in FIG. 1 at step 105. The data recorder 40 shown in FIG. 2 may also receive automotive usage data from one or more vehicle sensor(s). The vehicle subsystem 14 shown in FIG. 2 stores the automotive usage data received from the vehicle electrical infrastructure 16 shown in FIG. 1, or from the vehicle sensor(s), in the mass data storage unit 42 shown in FIG. 2 at step 110. The communications module 44 shown in FIG. 2 wirelessly transmits, such as via a cellular link or a WLAN communication), the automotive usage data stored in the mass data storage unit 42 shown in FIG. 2 to the back-office subsystem 20 shown in FIG. 1 at step 115. In an exemplary embodiment, the communications module 44 shown in FIG. 2 wirelessly transmits the automotive usage data stored in the mass data storage unit 42 shown in FIG. 2 to a collection node that is accessible by the back-office subsystem 20 shown in FIG. 1, such as via an Internet or other network connection. Additionally, the communications module 44 shown in FIG. 2 may wirelessly transmit the automotive usage data stored in the mass data storage unit 42 shown in FIG. 2 to the back-office subsystem 20 shown in FIG. 1 upon receipt of service requests from the back-office subsystem 20 shown in FIG. 1.

In addition to receiving service requests, the communications module 44 shown in FIG. 2 may also wirelessly receive updated retrieval instructions from the back-office subsystem 20. The mass data storage unit 42 shown in FIG. 2 stores the updated retrieval instructions or service requests for execution by the data recorder 40 shown in FIG. 2 and the communications module 44 shown in FIG. 2, respectively. In the event that updated retrieval instructions are received, the data recorder 40 shown in FIG. 2 receives automotive usage data from the vehicle electrical infrastructure 16 shown in FIG. 1 in accordance with the updated retrieval instructions.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A system for transferring automotive usage data from a vehicle electrical infrastructure to a remote site, the system comprising:
a data recorder in operable communication with the vehicle electrical infrastructure, said data recorder configured to retrieve the automotive usage data from the vehicle electrical infrastructure;
a mass storage unit in operable communication with said data recorder and configured to store the automotive usage data; and
a communication module coupled to said mass storage device and configured to wirelessly transmit the automotive usage data to the remote site.

2. A system according to claim 1, further comprising a vehicle sensor in operable communication with said data recorder and configured to provide the automotive usage data for transmission to the remote site.

3. A system according to claim 1, wherein said communication module is further configured to wirelessly receive information from the remote site and said mass storage unit is further configured to store the information from the remote site.

4. A system according to claim 1, wherein said communication module comprises a broadband transceiver.

5. A system according to claim 4, wherein said broadband transceiver is configured for cellular communication.

6. A system according to claim 4, wherein said broadband transceiver is configured for Wireless Local Area Network (WLAN) communication.

7. A system according to claim 1 further comprising a programmable power supply coupled to said data recorder and said communications module, said programmable power supply configured to supply power to said data recorder and said communications module based on a power management scheme.

8. A method of gathering automotive usage data of a vehicle at a remote site, the method comprising the steps of:
receiving the automotive usage data from a vehicle electrical infrastructure of the vehicle;
storing the automotive usage data received from the vehicle electrical infrastructure in a memory of the vehicle; and
wirelessly transmitting the automotive usage data stored in the memory to the remote site.

9. A method according to claim 8 further comprising the steps of:
receiving the automotive usage data from at least one vehicle sensor of the vehicle; and
storing the automotive usage data received from the at least one vehicle sensor of the vehicle in the memory of the vehicle.

10. A method according to claim 8 further comprising the steps of:
wirelessly receiving an updated retrieval instruction from the remote site; and
storing the updated retrieval instruction received from the remote site in the memory of the vehicle.

11. A method according to claim 10, wherein said step of receiving the automotive usage data further comprises the step of receiving the automotive usage data from the vehicle electrical infrastructure of the vehicle based on the updated retrieval instruction.

12. A method according to claim 8, wherein said step of wirelessly transmitting the automotive usage data stored in the memory comprises the step of wirelessly transmitting the automotive usage data stored in the memory to a collection node that is in operable communication 5 with the remote site.

13. A method according to claim 8, wherein said step of wirelessly transmitting the automotive usage data stored in the memory comprises the step of wirelessly transmitting the automotive usage data stored in the memory based on a power management scheme of the vehicle.

14. A method according to claim 8, wherein said step of wirelessly transmitting the automotive usage data stored in the memory comprises the step of transmitting the automotive usage data stored in the memory via a cellular link to the remote site.

15. A method according to claim 8, wherein said step of wirelessly transmitting the automotive usage data stored in the memory further comprises the step of transmitting the automotive usage data stored in the memory via a WLAN communication.

16. A method according to claim 8 further comprising the step of receiving a service request from the remote site, wherein said step of wirelessly transmitting the automotive usage data stored in the memory is performed in response to the service request from the remote site.

17. A system for acquiring automotive usage data from a vehicle, the system comprising:
a vehicle subsystem comprising:
a data recorder having an output and having a first input configured to couple with a vehicle electrical infrastructure of the vehicle, said data recorder configured to retrieve the automotive usage data from the vehicle electrical infrastructure; and
a mass storage unit having a first input coupled to said output of said data recorder and configured to store the automotive usage data;
a telematics subsystem configured to manage communications to and from said vehicle subsystem, said telematics subsystem comprising:
a collection node; and
a communication module coupled to said mass storage device and configured to transmit the automotive usage data to said collection node; and
a remote data processor configured to wirelessly receive the automotive usage data from said collection node via said communication module.

18. A system according to claim 17, wherein said vehicle subsystem further comprises a programmable power supply coupled to said data recorder and said communications module, said programmable power supply configured to supply power to said data recorder and said communications module based on a power management scheme of the vehicle.

19. A system according to claim 18, wherein said programmable power supply is configured to activate said vehicle subsystem at a predetermined power level.

20. A system according to claim 17, wherein said data recorder has a second input configured to couple with a vehicle sensor of the vehicle.
